(19) United States
(12) Patent Application Publication
(10) Pub. No.: US 2020/0043005 A1
(43) Pub. Date: Feb. 6, 2020

(54) SYSTEM AND A METHOD FOR DETECTING FRAUDULENT ACTIVITY OF A USER

(71) Applicant: IBS Software Services FZ-LLC, Dubai (AE)

(72) Inventors: Dilip Varma Damodaran, Trivandrum (IN); Viney Sharma, Trivandrum (IN); Nibin Jacob Panicker, Trivandrum (IN)

(21) Appl. No.: 16/054,272

(22) Filed: Aug. 3, 2018

(51) Int. Cl. G06Q 20/40; G06F 15/18; G06F 17/18; G06F 17/30

(52) U.S. Cl. CPC G06Q 20/4016; G06F 17/30994; G06F 17/18; G06F 15/18

(57) ABSTRACT

System and a method for detecting fraudulent activity of a user are described. The system receives data based on user's activity. The system determines a first score for the activity. The system compares the first score with a first predefined threshold. If the first score is greater than the first predefined threshold, the system classifies the activity as a potential fraud activity OR computes a second score for the activity. The system compares the second score with a second predefined threshold. If the second score is less than the second predefined threshold, the system classifies the activity as a non-fraudulent activity OR designates the activity as a potential fraud activity. The system generates and transmits a graphical model to the user. The system determines the potential fraud activity as a fraudulent activity based upon predefined rules or inputs received from the user based upon the analysis of the graphical model.

### TECHNICAL FIELD

The present subject matter described herein, in general, relates to a data processing and data mining techniques, and more particularly, to a computer implemented system and a method for detecting fraudulent activity of a user by processing data associated to the user.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Frauds in loyalty transactions or activities facilitated through loyalty programs are increasing at an alarming rate. Such frauds are usually termed as loyalty frauds. The loyalty programs are structured marketing strategies designed by merchants to encourage customers to continue to shop at or use the services of businesses associated with each program. These programs exist covering most types of commerce, each one having varying features and rewards-schemes. The loyalty fraud occurs when a customer or an employee finds a loophole in the system and exploits it for personal gain. Excessive or fraudulent redemption of reward points accumulated through a loyalty program is considered as a ‘loyalty fraud’.

It is difficult to quantify the actual size and impact of these loyalty frauds because most of the loyalty frauds goes undetected. Research estimates a cumulative liability of around $100 billion in airline loyalty programs alone. Such a huge liability sitting in the books is a big motive for frauds. Further, it has been observed that 72% of frequent flyer programs have been prey to fraudsters. 38% of these have experienced significant to very significant frauds. Further, it has been observed that 80% of fraud instances are discovered only by accident. Therefore, there is a lot to be discovered and a lot more to be done to effectively manage frauds.

Thus, in view of the above, there is a long-felt need for a system and a method for detecting and managing frauds effectively. There is a need for a mechanism that identifies suspect activities as and when they occur. Suspect activities are those that have a significant probability of being linked to a fraud. There is a need to have a system that can assess this probability from loyalty activities in near real-time. The system should have ability to detect frauds in loyalty activities in near real-time so that program revenue leakage due to frauds can be reduced. Further, the system should be able to validate activities genuineness with members early in the fraud cycle thus building trust with members.

### SUMMARY

This summary is provided to introduce the concepts related to a system and a method for detecting fraudulent activity of a user and the concepts are further described in the detail description. This summary is not intended to identify essential features of the claimed subject matter nor it is intended to use in determining or limiting the scope of claimed subject matter.

In one embodiment, a system for detecting fraudulent activity of a user is disclosed. The system may include a processor and a memory coupled with the processor. The processor may be configured to execute a plurality of programmed instructions stored in the memory. The processor may execute a programmed instruction for receiving data based on activity performed by a user. The processor may further execute a programmed instruction for determining a first score for the activity based upon the data of one or more historical activities similar to the activity. The processor may further execute a programmed instruction for comparing the first score with a first predefined threshold. If the first score is greater than the first predefined threshold, the processor may further execute a programmed instruction for classifying the activity as a potential fraud activity OR the processor may execute a programmed instruction for computing a second score for the activity based upon one or more data sets from a predefined learning set using machine learning technique. The processor may further execute a programmed instruction for comparing the second score with a second predefined threshold. If the second score is less than the second predefined threshold, the processor may further execute a programmed instruction for classifying the activity as a non-fraudulent activity OR the processor may execute a programmed instruction for designating the activity as a potential fraud activity. Further, if the activity is designated as a potential fraud activity, the processor may execute a programmed instruction for generating a graphical model representing a network of flow of one or more activities related to the said activity. The processor may further execute a programmed instruction for transmitting the graphical model to the user for analysis. The processor may further execute a programmed instruction for determining the potential fraud activity as a fraud activity based on a predefined set of rules or inputs received from the user based upon the analysis of the graphical model.

In another embodiment, a method for detecting fraudulent activity of a user is disclosed. The method may include receiving, via a processor, data based on activity performed by a user. The method may further include determining, via the processor, a first score for the activity based upon the data of one or more historical activities similar to the activity. The method may further include comparing, via the processor, the first score with a first predefined threshold. If the first score is greater than the first predefined threshold, the method may further include classifying, via the processor, the activity as a potential fraud activity OR the method may include computing, via the processor, a second score for the activity based upon one or more data sets from a predefined learning set using machine learning technique. The method may further include comparing, via the processor, the second score with a second predefined threshold. If the second score is less than the second predefined threshold, the method may further include classifying, via the processor, the activity as a non-fraudulent activity OR the method may include designating, via the processor, the activity as a potential fraud activity. Further, if the activity is designated as a potential fraud activity, the method may include generating, via the processor, a graphical model representing a network of flow of one or more activities related to the said activity. The method may further include transmitting, via the processor, the graphical model to the user for analysis. The method may further include determining, via the processor, the potential fraud activity as a fraud activity based on a predefined set of rules or inputs received from the user based upon the analysis of the graphical model.

In yet another embodiment, a non-transitory computer readable medium storing program for detecting fraudulent activity of a user is disclosed. The program may include a programmed instruction for receiving data based on activity performed by a user. The program may further include a programmed instruction for determining a first score for the activity based upon the data of one or more historical activities similar to the activity. The program may further include a programmed instruction for comparing the first score with a first predefined threshold. If the first score is greater than the first predefined threshold, the program may further include a programmed instruction for classifying the activity as a potential fraud activity OR the program may further include a programmed instruction for computing a second score for the activity based upon one or more data sets from a predefined learning set using machine learning technique. The program may further include a programmed instruction for comparing the second score with a second predefined threshold. If the second score is less than the second predefined threshold, the program may further include a programmed instruction for classifying the activity as a non-fraudulent activity OR the program may further include a programmed instruction for designating the activity as a potential fraud activity. Further, if the activity is designated as a potential fraud activity, the program may include a programmed instruction for generating a graphical model representing a network of flow of one or more activities related to the said activity. The program may further include a programmed instruction for transmitting the graphical model to the user for analysis. The program may further include a programmed instruction for determining the potential fraud activity as a fraud activity based on a predefined set of rules or inputs received from the user based upon the analysis of the graphical model.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a network implementation 100 of a system 101 for detecting fraudulent activity of a user, in accordance with an embodiment of a present subject matter.

FIG. 2 illustrates a system 101 and its components, in accordance with an embodiment of a present subject matter.

FIG. 3 illustrates an exemplary embodiment of a system 101 for detecting fraudulent activity of a user, in accordance with the embodiment of the present subject matter.

FIG. 4 illustrates different phases of a fraud pattern, in accordance with the embodiment of the present subject matter.

FIG. 5 illustrates a process flow graph of a system 101 for detecting fraudulent activity of a user, in accordance with the embodiment of the present subject matter.

FIG. 6 illustrates, representation of a graphical model to visualise the system 101 for detecting fraudulent activity of a user in accordance with the embodiment of the present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

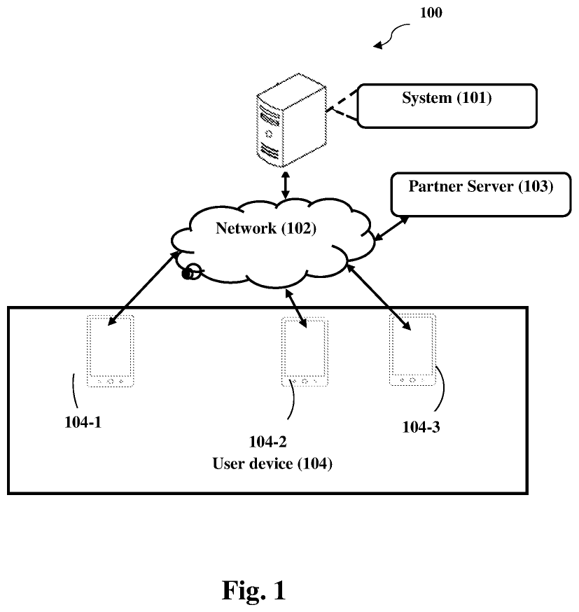

FIG. 1 illustrates a network implementation 100 of a system 101 for detecting fraudulent activity of a user, in accordance with an embodiment of a present subject matter. In one embodiment, the system 101 may be implemented as a server (hereinafter the system 101 is interchangeably referred as server 101). In an embodiment, the server 101 may be connected to a user device 104 over a network 102. It may be understood that the server 101 may be accessed by multiple users through one or more user devices 104-1,104-2,104-3 . . . 104-n, collectively referred to as user device 104 hereinafter, or user 104, or applications residing on the user device 104. The user 104 may be any person, machine, software, automated computer program, a robot or a combination thereof. Further, the user device 104 may be communicatively coupled with a partner server 103 (third-party server) directly or via the network 102. In one embodiment, the partner server 103 may indicate a third-party server enabling its registered users to subscribe to various services facilitated by the system 101. In one example, if the system 101 belongs to an Airline service provider providing loyalty program services to its customers, the partner server 103 may belong to a hotel enabling its guests to participate in the airline loyalty program facilitated by the system 101.

In an embodiment, though the present subject matter is explained considering that the system 101 is implemented as a server, it may be understood that the system 101 may also be implemented in a variety of user devices, such as a but are not limited to, a portable computer, a personal digital assistant, a handheld device, a mobile, a laptop computer, a desktop computer, a notebook, a workstation, a mainframe computer, and the like. In one embodiment, the system 101 may be implemented in a cloud-computing environment. In an embodiment, the network 102 may be a wireless network, a wired network or a combination thereof. The network 102 can be accessed by the user device 104 using wired or wireless network connectivity means including updated communications technology.

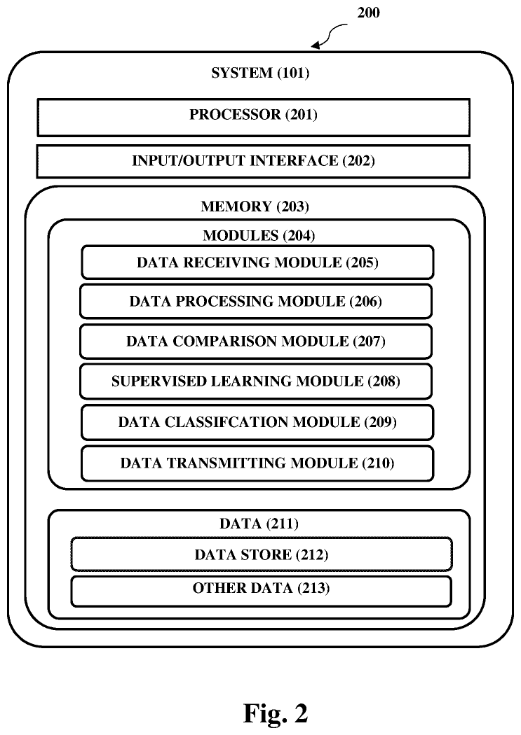

Referring to FIG. 2, a system 101 and its components are shown, in accordance with an embodiment of a present subject matter. The system 101 may comprise at least one processor 201, an input/output (I/O) interface 202 and memory 203.

In one embodiment, the at least one processor 201 is configured to fetch and execute computer-readable instructions stored in the memory 203. In one embodiment, the I/O interface 202 may include a variety of software and hardware interfaces, for example, a web interface, a Graphical User Interface (GUI), and the like. The I/O interface 202 may allow the user device 104 to interact with the server 101. Further, the I/O interface 202 may enable the user device 104 to communicate with other computing devices. The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting to another server 103.

In one embodiment, the I/O interface 202 is an interaction platform that facilitates interaction between user device 104 and system 101. The I/O interface 202 may allow commands for a command line interface or GUI which may enable a user to create, modify and delete either of data, metadata, program, logic, algorithm, parameters associated with encryption method, encryption program and encryption language. In one embodiment, the memory 203 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and memory cards. The memory 203 may comprise modules 204 and data 211.

In one embodiment, the modules 204 may comprise routines, programs, objects, components, data structure, etc., which performs particular tasks, functions or implement abstract data types. The modules 204 may further include a data receiving module 205, a data processing module 206, a data comparison module 207, a supervised learning module 208 a data classification module 209 and a data transmitting module 210. The data 211 may further comprise a data store 212 and other data 213.

In one embodiment, the data receiving module 205 may receive data. The data may be based on activity performed by the user. In one embodiment, the activity performed by the user may include, but are not limited to, enrolment to a certain program, purchasing a product, travelling, etc. In one embodiment, there may be multiple activities available. The activities may be validated based on one or more factors such as but are not limited to matching names, checking for double dipping, checking for impossible itineraries, etc.

In one embodiment, the data processing module 206 may determine a first score for the activity based upon the data of one or more historical activities similar to the activity. The first score may be generated by using a statistical outlier detection technique. In one exemplary embodiment, the statistical outlier detection technique may include a modified Z-score method. The modified Z-score method may be used to score the activity considering the history of similar activities (hereinafter referred as historical activities) in a peer group of the users who have performed the activities. The peer group may be a user's tier or a specific segment involving the tier, country of residence, and gender, etc.

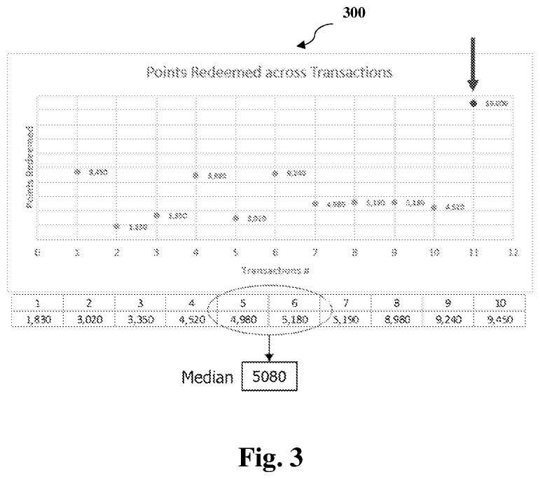

Consider that the user has done a redemption for 19,000 points. Assume that the user belongs to a tier whose users have a history of past redemptions as shown in FIG. 3.

Median for the historical activities, R_{M}=5080

Further, a Median Absolute Deviation (MAD) is a median of absolute deviations from the median for the historical activities R_{M}.

MAD=Median(|R₁−R_{M}|, . . . ,|Rₙ₋₁−R_{M}|)

Here, n=11

|R₁−R_{M}|=|1830−5080|=3250

|R₂−R_{M}|=|3020−5080|=2060

|R₃−R_{M}|=|3350−5080|=1730

|R₄−R_{M}|=|4520−5080|=560

|R₅−R_{M}|=|4980−5080|=100

|R₆−R_{M}|=|5180−5080|=100

|R₇−R_{M}|=|5190−5080|=|10

|R₈−R_{M}|=|8980−5080|=3900

|R₉−R_{M}|=|9240−5080|=4160

|R₁₀−R_{M}|=|9450−5080|=4370

Now, arrange the above values in ascending order as below:

The first score (S1) may be defined as:

S1=|(0.6745*(Rn−RM))/MAD|

S1=|(0.6745*(19000−5080))/1895|

S1=4.95

The value of S1 is always positive. If the value of S1 comes negative, then the absolute value of S1 is considered for further analysis.

In one embodiment, the data comparison module 207 may compare the first score with a first predefined threshold. In one embodiment, the data classification module 209 may classify the activity as a potential fraud activity if the first score is greater than or equal to the first predefined threshold. In one exemplary embodiment, consider the value of the first predefined threshold is 3.5. Therefore, in the above exemplary embodiment, since the first score (i.e. 4.95) is determined to be greater than the first predefined threshold (i.e. 3.5), the said activity of redemption of 19000 points by the user may be classified as the potential fraud activity.

In one embodiment, if the first score is less than the first predefined threshold, the supervised learning module 208 may compute a second score for the activity based upon the one or more data sets from a predefined learning set. The second score may be generated by using a supervised learning technique. The supervised learning technique may use neural networks or decision trees. These methods are based on the ability to train the supervised learning module 208 to detect/learn patterns.

In one embodiment, the supervised learning technique uses a supervised learning algorithm. The supervised learning algorithm may be enabled to map the “activity to labels”. Here, the labels may be the fraudulent activity and the non-fraudulent activity. Further, the user may decide to label the probabilities into the labels. For example, the user may decide that the probability below 80% is considered as the non-fraudulent activity and the probability above 80% is considered as the fraudulent activity. Further, the supervised learning algorithm tries to make the mapping perfect until it reaches to certain level of accuracy. Presence of learned patterns in an unseen activity may trigger the supervised learning algorithm to classify the activity as the fraudulent activity or non-fraudulent activity accordingly. Further, in order to learn classification, the predefined learning set may be used.

In one embodiment, the predefined learning set may comprise one or more prestored fraudulent and non-fraudulent patterns derived from the historical activities. Each record of the predefined learning set may comprise attributes such as but are not limited to:
An activity identifier,
An activity details (date, time, etc.),
An initiator details (name, demographics, whether member or agent initiated),
Beneficiary details (destination program, account)
Activity source (channel, IP, device, user-agent, location, partner)
Activity type (success, failure)
Account details (loyalty account number, balance)
Historical aggregates (recency and frequency per activity type and partner)
Value (points)
Value thresholds (z-score of segment)

Frauds are not instantaneous. Frauds usually consist of seemingly independent activities that are interconnected is some form, which together build up volume and value for the fraudster. We believe there are three phases to fraud.
1. Access
2. Build
3. Convert

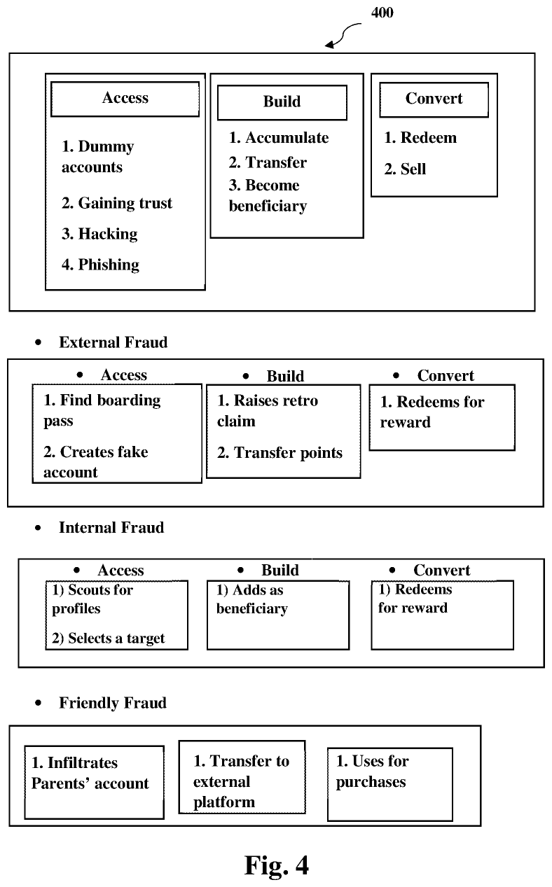

This may be called ‘ABC of fraud’. Every fraud involves some form of Access, Build and Covert. Together they create a pattern. An example of how fraud patterns have three phases is shown in FIG. 4.

The predefined learning set used for the supervised learning technique may reflect known scenarios and patterns. An example list of ABC scenarios and how they come together in patterns is shown below.

TABLE 1

| No. | (A)ccess | (B)uild | (C)onvert |
|---|---|---|---|
| 1. | Dummy | Enrolment with | External Points |
| | Enrolment | Bonus Points | Transfer |
| 2. | Stealing | Retroclaim | Redemption |
| | Loyalty, A/C | | |
| | Password | | |
| 3. | Mis-use of trust | Internal Points | Personal Data Leak |
| | to gain password | Transfer | (Member Profile |
| | | | Details) |
| 4. | Session | Campaign | Use Voucher |
| | Hijacking | Eligibility, | |
| | Use session id | Incentives Agent- | |
| | for other | Points, | |
| | requests | Discounted | |
| | | Rewards | |
| 5. | Request | Adding Beneficiary | Soft Benefits |
| | Manipulation | | (Lounge access, |
| | (Token, | | Fake cards) |
| | Protected | | |
| | Service) | | |

TABLE 2

| No. | Pattern | Data Required |
|---|---|---|
| 1. | Possible duplicate - | Name, Demographics, |
| | Single profile | Address, Email |
| 2. | Fraudulent profile Creation | Name, Gender, Time, |
| | Multiple profiles | Location, IP, Device |
| 3. | Suspicious individual | IP, Device, User Agent, |
| | Login | Location |
| 4. | Brute-force attack | IP, Location, Frequency, |
| | | Action |
| 5. | Session/account hijacking | Membership no. in Txn, |
| | | Membership no. in |
| | | session |
| 6. | Abnormal Agent actions | User code, Action, |
| | | Frequency, Sequence |
| 7. | Abnormal frequency in | Membership no., Activity, |
| | Member activities | Frequency |
| 8. | Failed activities | IP, Location, Frequency, |
| | | Transaction, Type, Error code |

It must be noted herein that each fraudulent activity may include one or more of the aforementioned ABC scenarios (Table 1). Each of these ABC scenarios may be detected in an activity by monitoring pattern of the respective activity based upon the data associated with the said respective activity. Table 2 above depicts the data required for monitoring a particular activity and accordingly determining ABC scenario for the respective activity to determine whether the activity is the fraudulent activity. In one example, as shown in Table 2, for a pattern failed transactions (Row 8 of Table 2), the data including IP, location, frequency, Transaction, Type, Error code may be analyzed.

The predefined learning set may represent the above scenarios through records with the attributes (mentioned above) with an identifier flag mentioning whether the record represents a fraud or not. The supervised learning algorithms may use this data and learn to classify activities representing fraud or non-fraud. In one embodiment, the predefined learning sets used by the supervised learning technique may be continuously updated by feeding a fraudulent or non-fraudulent pattern derived from the fraudulent activity or non-fraudulent activities respectively.

In one embodiment, the data comparison module 207 may compare the second score with a second predefined threshold. If the second score is less than the second predefined threshold, the data classification module 209 may classify the activity as a non-fraudulent activity. Further, if the second score is greater than the second predefined threshold, the data classification module 209 may designate the activity as a potential fraud activity. In one embodiment, the second score may represent a probability of the activity of being fraud. Further, the range of the second score may lie between 0 to 1, wherein 1 represents highest probability of the activity of being fraud.

In one embodiment, once the activity is designated as the potential fraud activity, the data processing module 206 may generate a graphical model representing a network of flow of one or more activities related to the said activity. Further, the data transmitting module 210 may transmit the graphical model that is generated, to the user for further analysis. In one embodiment, the data processing module 206 may determine the potential fraud activity as a fraud activity by executing a predefined set of rules based on the first scores and the second scores or by acting on inputs received from the user based upon the analysis of the graphical model. The predefined set of rules may comprise such as but are not limited to blocking the said activity of an account holder, blocking an account of the account holder if at least one of the first score and/or the second score represents a high probability of the activity of being fraud, notifying the user about the high probability of the activity of being fraud, etc.

In an exemplary embodiment, consider the first score of the activity is 8.5 (high) and/or the second score of the activity is 0.95. Since the first score and/or the second score of the activity is high, the system 101 will notify the user about the high score/probability and enable the use to further analysis the activity. In another exemplary embodiment, consider the first score of the activity is 9 (higher) and/or the second score of the activity is 0.98. Since the first score and/or the second score of the activity is too high (higher than the above case), the system 101 will directly block the activity. In yet another exemplary embodiment, consider the first score of the activity is 10 (highest) and/or the second score of the activity is 0.99 or 1. Since the first score and/or the second score of the activity is too high (highest of all the above cases), the system 101 will directly block the account of the account holder. In such case, once the account of the account holder is blocked, all the further activities of the account will be blocked i.e. the account holder will not be able to make any activity from the account.

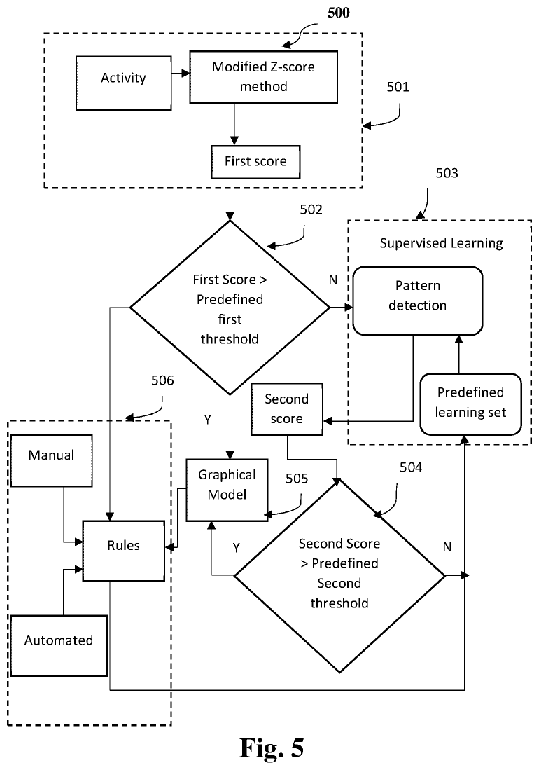

Now referring to FIG. 5, a process flow graph 500 of a system 101 for detecting fraudulent activity of a user is illustrated, in accordance with the embodiment of the present subject matter.

At step 501, the data receiving module 205 may receive data. The data received may be based on activity performed by the user. In one embodiment, the data processing module 206 may determine a first score for the activity based upon the data of one or more historical activities similar to the activity. The first score may be generated by using a statistical outlier detection technique. In one exemplary embodiment, the statistical outlier detection technique may include a modified Z-score method. The modified Z-score method may be used to score the activity considering the history of similar activities (hereinafter referred as historical activities) in a peer group of the users who have performed the activities. The peer group may be a user's tier or a specific segment involving the tier, country of residence, and gender, etc.

At step 502, the data comparison module 207 may compare the first score with a first predefined threshold. In one embodiment, the data classification module 209 may classify the activity as a potential fraud activity if the first score is greater than or equal to the first predefined threshold.

At step 503, if the first score is less than the first predefined threshold, the supervised learning module 208 may compute a second score for the activity based upon the one or more data sets from a predefined learning set. The second score may be generated by using a supervised learning technique. The supervised learning technique may use neural networks or decision trees. These methods are based on the ability to train the supervised learning module 208 to detect patterns.

At step 504, the data comparison module 207 may compare the second score with a second predefined threshold. If the second score is less than the second predefined threshold, the data classification module 209 may classify the activity as a non-fraudulent activity. Further, if the second score is greater than the second predefined threshold, the data classification module 209 may designate the activity as a potential fraud activity.

At step 505, once the activity is designated as the potential fraud activity, the data processing module 206 may generate the graphical model representing a network of flow of one or more activities related to the said activity. Further, the data transmitting module 210 may transmit the graphical model that is generated, to the user for further analysis.

At step 506, the data processing module 206 may determine the potential fraud activity as a fraud activity based on a predefined set of rules or inputs received from the user based upon the analysis of the graphical model.

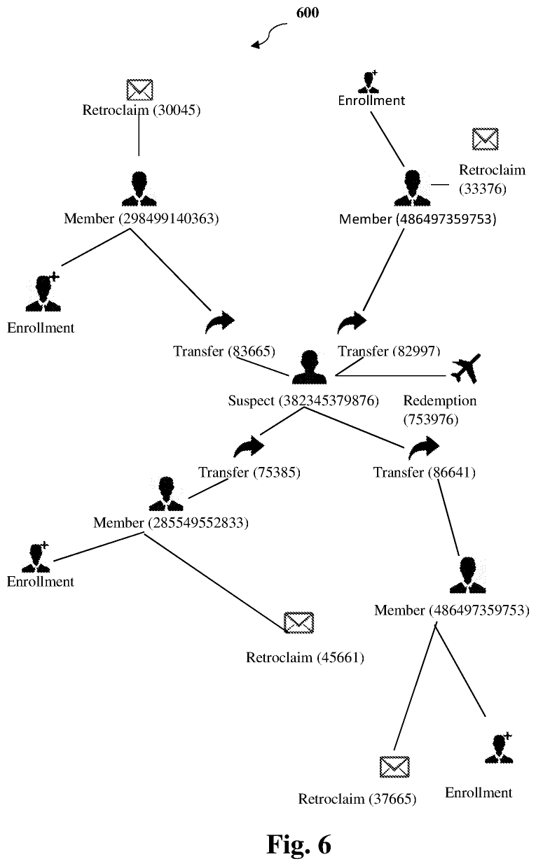

FIG. 6 illustrates, representation of a graphical model to visualise the system 101 for detecting fraudulent activity of a user in accordance with the embodiment of the present subject matter. The graphical model representing a network of flow of one or more activities that may be linked to each other. In an exemplary embodiment, FIG. 6 shows multiple enrolments being made (in different names possibly based on abandoned boarding passes) and then points being gradually transferred to a target account where it gets accumulated. The numbers in brackets are identifiers (like membership number, activity number). Further, the graphical model may be intended to help the user to visualize the network of the activities and to investigate. Each path may also be weighted with the associated points so that the cumulative weight at suspect node may be computed.

Although implementations for a system and a method for detecting fraudulent activity of a user have been described in language specific to structural features and/or methods, it is to be understood that the appended claims are not necessarily limited to the specific features or methods described. Rather, the specific features and methods are disclosed as examples of implementations for detecting fraudulent activity of a user.

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

1. A system for detecting fraudulent activities of a user, the system comprising:
a processor; and
a memory coupled with the processor, wherein the processor is configured to execute a plurality of programmed instructions stored in the memory, the plurality of programmed instructions comprises:
receiving, data based on an activity performed by a user;
determining, a first score for the activity based upon the data of one or more historical activities similar to the activity;
classifying, the activity as a potential fraud activity, when the first score is greater than a first predefined threshold;
computing, a second score for the activity based upon one or more data sets from a predefined learning set using a machine learning technique, when the first score is less than the first predefined threshold;
classifying, the activity as a potential fraud activity, when the second score is greater than a second predefined threshold;
generating, a graphical model representing a network of flow of one or more activities related to the activity, when the activity is designated as the potential fraud activity;
and
determining, the potential fraud activity as a fraud activity based upon the analysis of the graphical model using a predefined set of rules.

2. The system of claim 1, wherein the activity performed by the user is one of enrolment to a certain program, purchasing a product, and travelling.

3. The system of claim 1, wherein the first score is generated by using a statistical outlier detection technique, wherein the statistical outlier detection technique is at least a modified Z-score method.

4. The system of claim 1, wherein the machine learning technique used to compute the second score is a supervised learning technique.

5. The system of claim 1, wherein the predefined learning set comprises one or more prestored fraudulent and non-fraudulent patterns derived from historical activities.

6. The system of claim 5, wherein the predefined learning sets is continuously updated by feeding a fraudulent or non-fraudulent pattern derived from the fraudulent activities or non-fraudulent activities respectively.

7. The system of claim 1, wherein the second score represents a probability of the activity of being fraud.

8. The system of claim 7, wherein a range of the second score is between 0 to 1, wherein 1 represents highest probability of the activity of being fraud.

9. The system of claim 8, wherein the predefined set of rules comprises at least one of blocking the activity of an account holder, blocking an account of the account holder if the first score, or the second score represents a high probability of the activity of being fraud, and notifying the user about the high probability of the activity of being fraud.

10. A method for detecting fraudulent activities of a user, the method comprising:
receiving, via a processor, data based on an activity performed by a user;
determining, via the processor, a first score for the activity based upon the data of one or more historical activities similar to the activity;
classifying, via the processor, the activity as a potential fraud activity, when the first score is greater than a first predefined threshold;
computing, via the processor, a second score for the activity based upon one or more data sets from a predefined learning set using a machine learning technique, when the first score is less than the first predefined threshold;
classifying, via the processor, the activity as a potential fraud activity, when the second score is greater than a second predefined threshold;
generating, via the processor, a graphical model representing a network of flow of one or more activities related to the activity, when the activity is designated as the potential fraud activity;
and
determining, via the processor, the potential fraud activity as a fraud activity based upon the analysis of the graphical model using a predefined set of rules.

11. The method of claim 10, wherein the activity performed by the user is one of enrolment to a certain program, purchasing a product, and travelling.

12. The method of claim 10, wherein the first score is generated by using a statistical outlier detection technique, wherein the statistical outlier detection technique is at least a modified Z-score method.

13. The method of claim 10, wherein the machine learning technique used to compute the second score is a supervised learning technique.

14. The method of claim 10, wherein the predefined learning set comprises one or more prestored fraudulent and non-fraudulent patterns derived from historical activities.

15. The method of claim 10, further comprising continuously updating the predefined learning sets by feeding a fraudulent or non-fraudulent pattern derived from the fraudulent activities or non-fraudulent activities respectively.

16. The method of claim 10, wherein the second score represents a probability of the activity of being fraud.

17. The method of claim 16, wherein a range of the second score is between 0 to 1, wherein 1 represents highest probability of the activity of being fraud.

18. The method of claim 17, wherein the predefined set of rules comprises at least one of blocking the activity of an account holder, blocking an account of the account holder if the first score, or the second score represents a high probability of the activity of being fraud, and notifying the user about the high probability of the activity of being fraud.

19. A non-transitory computer readable medium storing program for detecting fraudulent activities of a user, the program comprising a plurality of programmed instructions, the plurality of programmed instructions comprises:
receiving, data based on an activity performed by a user;
determining, a first score for the activity based upon the data of one or more historical activities similar to the activity;
classifying, the activity as a potential fraud activity, when the first score is greater than a first predefined threshold;
computing, a second score for the activity based upon one or more data sets from a predefined learning set using a machine learning technique, when the first score is less than the first predefined threshold;
classifying, the activity as a potential fraud activity, when the second score is greater than the second predefined threshold,
generating, a graphical model representing a network of flow of one or more activities related to the activity, when the activity is designated as the potential fraud activity;
and
determining, the potential fraud activity as a fraud activity based upon the analysis of the graphical model using a predefined set of rules.
